(19) United States
(12) Patent Application Publication
(10) Pub. No.: US 2004/0078792 A1
(43) Pub. Date: Apr. 22, 2004

(54) System and method for selectively deactivating auto-deploy functionality of a software input panel

(75) Inventor: Chee H. Chew, Redmond, WA (US)

Correspondence Address: MERCHANT & GOULD, P.O. BOX 2903, MINNEAPOLIS, MN, 55402-0903, US

(73) Assignee: Microsoft Corporation, Redmond, WA (US)

(21) Appl. No.: 10/422,870

(22) Filed: Apr. 23, 2003

Related U.S. Application Data
(60) Provisional application No. 60/420,198, filed on Oct. 21, 2002.

(51) Int. Cl. G06F 9/44

(52) U.S. Cl. 717/168; 717/171; 717/176

(57) ABSTRACT

A mobile device selectively deactivates and reactivates software input panel (SIP) auto-deploy functionality. A software input panel is automatically displayed if a user needs to enter data. The present invention allows the mobile device to utilize space on the display more effectively if a physical keyboard is coupled to the mobile device. If a physical keyboard is coupled to the mobile device and a key is pressed on the physical keyboard, the present invention hides the software input panel, and deactivates the software input panel auto-deploy functionality. Software input panel auto-deploy is reactivated if the user manually launches the software input panel.

### RELATED APPLICATIONS

This application claims the benefit of U.S. Provisional Application No. 60/420,198 filed on Oct. 21, 2002, which is hereby claimed under 35 U.S.C. §119(e).

### FIELD OF THE INVENTION

This invention relates to computer systems, and in particular, to selectively deactivating auto-deploy functionality for a software input panel on a mobile device.

### BACKGROUND OF THE INVENTION

Small, mobile computing devices, such as hand-held and pocket-sized computers, tablet personal computers, and the like, are becoming important and popular user tools. In general, they have become small enough to be extremely convenient, while consuming less battery power, and at the same time have become capable of running more powerful applications.

Although the computing circuitry of such devices continues to shrink, size limitations are being reached as a result of human limitations. For example, a full character keyboard that enables user data input cannot be so small that human fingers cannot depress the individual keys. As a result, some devices have eliminated physical keyboards, and instead use a software input panel (SIP). A SIP can be used as a means of data entry, without the need for a physical or external keyboard. The SIP is launched within a window on the screen. The SIP is a representation of a keyboard that appears on the screen, which may have a touch-sensitive display. The user can touch keys on the SIP with a stylus. If the user touches a key on a software panel with a stylus, the computer responds in a similar manner as if such a key was pressed on a physical keyboard.

For example, the SIP may display the image of a keyboard on the screen. If a user taps one of the keys, the tap is detected as screen coordinates. The SIP then converts the tap into a character corresponding to the button that the user tapped. These characters are then sent through a software input method managing component to the system.

The mobile device may automatically deploy the SIP if certain applications are used or launched by the user. However, in some circumstances, the user may be using hardware buttons on the mobile device to navigate in an application. In those cases, the SIP is not being used but is consuming valuable screen space.

### SUMMARY OF THE INVENTION

The present invention is directed to selectively deactivating auto-deploy functionality for a software input panel (SIP) on a mobile device. The present invention is directed to modifying the display characteristics of the SIP when an input device session is started. Previously, the SIP would automatically launch for a pre-determined set of circumstances that anticipated the user's desire to use the SIP. In one aspect of the present invention, the SIP is removed if already launched and the auto-deploy functionality is disabled in circumstances where it is determined that the user is likely to prefer using an alternative input mechanism. Accordingly, the amount of useful screen space for mobile computer devices is increased if the SIP is not useful.

A more complete appreciation of the present invention and its improvements can be obtained by reference to the accompanying drawing, which is briefly summarized below, to the following detailed description of illustrated embodiments of the invention, and to the appended claims.

### BRIEF DESCRIPTION OF THE DRAWINGS

FIG. 1 illustrates an exemplary mobile device in which embodiments of the present invention are implemented;

FIG. 2 is a logical block diagram illustrated components of a system that is arranged in accordance with aspects of the prevent invention; and

FIG. 3 is a logic flow diagram that illustrates a process for selectively deactivating and reactivating a software input panel, according to aspects of the present invention.

### DETAILED DESCRIPTION OF THE INVENTION

The present invention is related to selectively deactivating and reactivating the SIP auto-deploy functionality. According to one example, a physical keyboard is integrated with the mobile device. According to another example, the physical keyboard is a separate device that may be attached and detached from the mobile device. The physical keyboard may be directly connected to the mobile device. Alternatively, the keyboard may be coupled to the mobile device through one or more intermediary devices. For example, the keyboard may be connected to a computer, wherein the computer is connected to the mobile device.

According to one example, the SIP may be hidden if the user presses a key on the physical keyboard. Additionally, SIP auto-deploy may be disabled if the user presses a key on the physical keyboard. According to another example, the SIP may be hidden and the SIP auto-deploy may be disabled if a method of input other than the SIP is used.

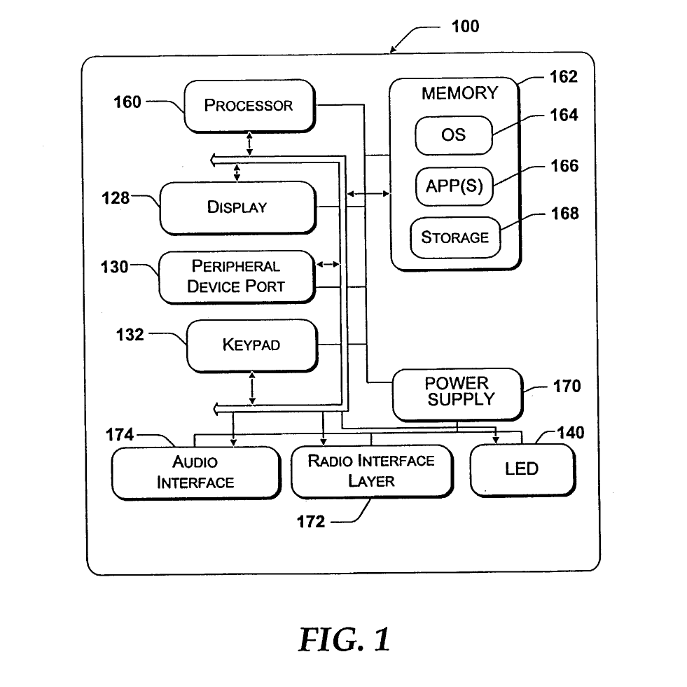

With reference to FIG. 1, one exemplary system for implementing the invention includes a computing device configured as a mobile device, such as mobile device 100. The mobile device 100 has a processor 160, a memory 162, a display 128, peripheral device port 130, and a keypad 132. The memory 162 generally includes both volatile memory (e.g., RAM) and non-volatile memory (e.g., ROM, Flash Memory, or the like). The mobile device 100 includes an operating system 164, such as the Windows CE operating system from Microsoft Corporation or other operating system, which is resident in the memory 162 and executes on the processor 160. The keypad 132 may be a push button numeric dialing pad (such as on a typical telephone), a multi-key keyboard (such as a conventional keyboard). The display 128 may be a liquid crystal display, or any other type of display commonly used in mobile devices. The display 128 may be touch-sensitive, and would then also act as an input device. The peripheral device port 130 may be of the type to accept additional memory cards, game cards, modem cards, or other peripheral devices.

One or more application programs 166 are loaded into memory 162 and run on the operating system 164. Examples of application programs include phone dialer programs, installation wizard programs, email programs, scheduling programs, PIM (personal information management) programs, word processing programs, spreadsheet programs, Internet browser programs, and so forth. The mobile computing device 100 also includes non-volatile storage 168 within the memory 162. The non-volatile storage 168 may be used to store persistent information which should not be lost if the mobile computing device 100 is powered down. The applications 166 may use and store information in the storage 168, such as e-mail or other messages used by an e-mail application, contact information used by a PIM, appointment information used by a scheduling program, documents used by a word processing program, device driver programs, and the like.

The mobile computing device 100 has a power supply 170, which may be implemented as one or more batteries. The power supply 170 might further include an external power source, such as an AC adapter or a powered docking cradle, which supplements or recharges the batteries.

The mobile computing device 100 is also shown with two types of external notification mechanisms: an LED 140 and an audio interface 174. These devices may be directly coupled to the power supply 170 so that if activated, they remain on for a duration dictated by the notification mechanism even though the processor 160 and other components might shut down to conserve battery power. The LED 140 may be programmed to remain on indefinitely until the user takes action to indicate the powered-on status of the device. The audio interface 174 is used to provide audible signals to and receive audible signals from the user. For example, the audio interface 174 may be coupled to a speaker for providing audible output and to a microphone for receiving audible input, such as to facilitate a telephone conversation.

The mobile computing device 100 also includes a radio interface layer 172 that performs the function of transmitting and receiving radio frequency communications. The radio interface layer 172 facilitates wireless connectivity between the mobile computing device 100 and the outside world, via a communications carrier or service provider. Transmissions to and from the radio interface layer 172 are conducted under control of the operating system 164. In other words, communications received by the radio interface layer 172 may be disseminated to application programs 166 via the operating system 164, and vice versa.

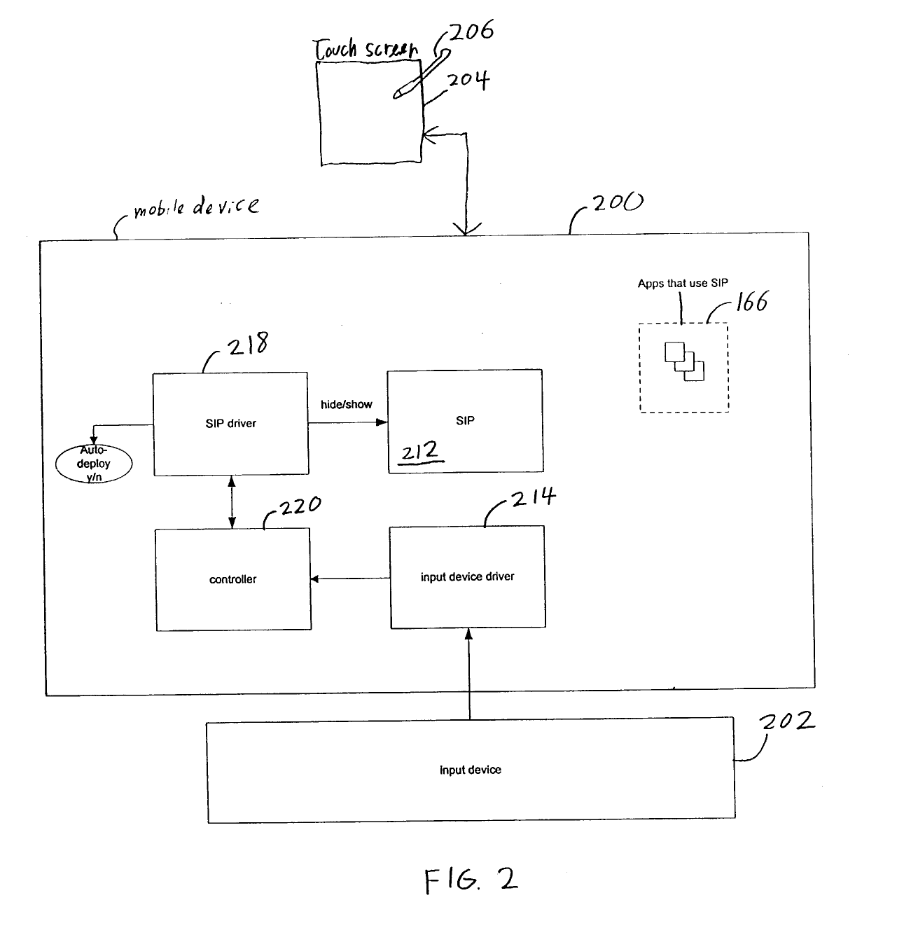

FIG. 2 is a logical block diagram illustrating components of a system that is arranged in accordance with aspects of the present invention. Illustrated in FIG. 2 are several components that implement one example of the present invention in a mobile device 200.

FIG. 2 includes a mobile device 200, an input device 202, a touch screen 204, and a stylus 206. The mobile device 200 includes application programs 166, a SIP 212, an input device driver 214, a SIP driver 218, and a controller 220.

The input device 202 and the touch screen 204 are alternative means for entering input for the mobile device 200. The stylus 206 may be used in conjunction with the touch screen 204 for entering input for the mobile device 200.

The input device 202 may include any means of input other than the SIP. According to one example, the input device 202 may be a physical keyboard. According another example, the input device 202 may be a voice dictation input. The input device 202 may be a hardware input device other than a physical keyboard. Alternatively, the input device 202 may be a software means of input other than the SIP.

Shown in FIG. 2 are applications 166 that accept input from many means, such as by input device 202 or touch screen 204. Examples of the applications 166 that accept input include word processors, spreadsheets, email programs, or the like.

The SIP 212 is used in conjunction with the touch screen 204 as an alternative to the input device 202. The SIP 212 is displayed on the screen and the user selects, using the stylus 206, icons representing buttons.

The SIP driver 218 controls the SIP 212 and includes a SIP auto-deploy mechanism. The SIP driver 218 may respond to signals from and send signals to the controller 220. According to one example, the SIP auto-deploy automatically launches the SIP 212 under certain pre-determined circumstances. The pre-determined circumstances may include launching certain programs such as applications 166 where a user is likely to input information using the SIP. The SIP driver 218 causes the SIP 212 to appear if such a program is opened and the SIP 212 is not already displayed on the screen.

As another example, the SIP driver 218 may also launch the SIP to be displayed if the cursor enters an input field in which data must be entered. The likelihood that a user may require the SIP 212 increases if the cursor enters a field that requires data entry.

In a further example, the SIP driver 218 may launch the SIP 212 if the state of any application currently running likely requires data entry. The auto-deploy functionality provides convenience to users by launching the SIP 212 if the user is likely to require the SIP 212 for data entry.

The input device driver 214 monitors the input device 202. According to one example, if a key is pressed on the input device 202, the input device driver 214 sends an event to the controller 220.

The controller 220 controls the SIP driver 218. The controller 220 receives events from the SIP driver 218 and input device driver 214. Controller 220 selectively activates and deactivates SIP auto-deploy functionality in response to the events from the SIP driver 218 and the input driver 214. According to one example, the controller 220 is in the shell (not shown).

The controller 220 causes the SIP 212 to be hidden (e.g. removed) if an input device session has started when the SIP 212 is currently on the screen. Additionally, if an input device session has started, the controller 220 disables SIP auto-deploy, so that the SIP 212 does not launch again until the input device session has ended. Preventing the SIP 212 from automatically launching allows the user to open and close various applications 166 that may require data input while keeping the SIP 212 hidden. The SIP 212 will not consume area on the display of the mobile device after the user has selected input data using the input device, and the user will not have to constantly remove the SIP 212 from the display every time it is automatically launched. Keeping the SIP 212 hidden increases the useful screen space on the mobile device if a physical keyboard is connected.

According to one example, it is evaluated that an input device session has started if a key has been pressed on a physical keyboard. The pressed key registers with the mobile device if the physical keyboard is coupled to the mobile device. Correspondingly, a physical keyboard may not be coupled to the mobile device if no key press registers with the mobile device.

According to one example, it is evaluated that an input device session has started if an external physical keyboard has been attached to the mobile device.

According to another example, it is evaluated that an input device session has started if one of a set of predetermined keys has been pressed on a physical keyboard. In one example, the set of pre-determined keys includes every key on the external keyboard, so that it is evaluated that an input device session has started if any key has been pressed on a physical keyboard. In another example, the set of pre-determined keys consists of the alphanumeric keys on the physical keyboard, so that it is evaluated that the input device session has started if an alphanumeric key has been pressed on the physical keyboard. According to one example, the set of pre-determined keys does not include keys that the user might press if the user is still using the stylus. For example, the set of pre-determined keys may not include keys such as application keys, direction pads, or rockers, because the user may still be using the stylus even though the user pressed one of those keys.

According to one example, evaluating whether one of the set of pre-determined keys on a physical keyboard has been pressed is implemented as follows. A shell is notified if a hardware key is pressed. The event of a hardware key being pressed is set on the “down.” That is, the event is set if the key is initially pressed downward. Sample code for implementing this feature is shown below:

```
v_hevtKeyPressed = CreateEvent(NULL,
    /*bManualReset */FALSE,
/*bInitialState */FALSE,
TEXT(“_KeyPress”));
    SetEvent(v_hevtKeyPressed);
```

The controller 220 causes the SIP auto-deploy to reactivate if the keyboard session is over. There are a number of different ways to evaluate whether the input device session is over. According to one example, it is evaluated that the input device session is over if the user has manually launched the SIP 212 using an available software input method. For example, the user may select an icon corresponding to the SIP 212. According to another example, it is evaluated that the input device session is over if a key has not been pressed on the keyboard 202 for a predetermined period of time. According to another example, the input device session is over if the stylus (206) is tapped on the screen. According to another example, the input device session is over if sensors on the mobile device 200 determine that the stylus 206 has been removed from a holder. A mobile device 200 may include a holder (not shown) on the side of the mobile device 200 that is used to hold the stylus 206 when the stylus 206 is not being used.

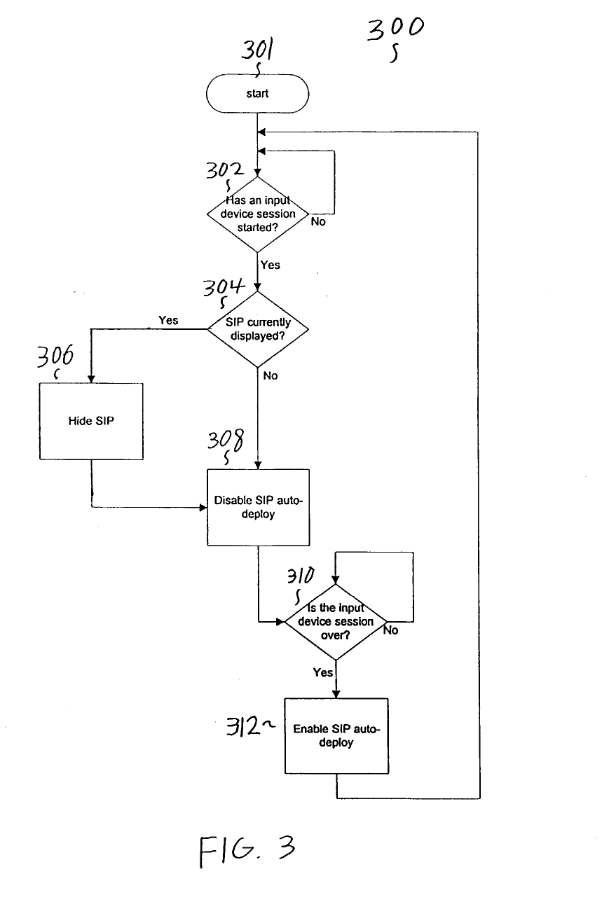

FIG. 3 is a logic flow diagram that illustrates a process 300 for selectively deactivating and reactivating a software input panel, according to aspects of the invention. Process 300 removes the software input panel from the display of the mobile device, and prevents auto-deploy of the SIP while an input device is being used. Process 300 begins at start block 301, where a mobile device that is activated. Processing then proceeds from start block 301 to decision block 302.

At decision block 302, it is evaluated whether an input device session has started. The process returns to decision block 302 if the input device session has not started. Alternatively, the process proceeds to from decision block 302 to decision block 304 if the input device session has started. At decision block 304, it is evaluated whether the SIP is currently displayed on the screen. Process 300 advances from decision block 304 to block 308 if the SIP is not currently displayed on the screen. Alternatively, process 300 proceeds to from decision block 304 to block 306 if the SIP is displayed on the screen.

At block 306, the SIP currently displayed on the mobile device is hidden (e.g., removed). The process then proceeds from block 306 to block 308. At block 308, the SIP auto-deploy mechanism is disabled. Process 300 then proceeds to from block 308 to decision block 310. At decision block 310, it is evaluated whether the input device session is over. Process 300 proceeds from decision block 310 to decision block 312 if the input device session is over. Alternatively, process 300 returns to decision block 310 if the input device session is not over.

At block 312, the SIP auto-deploy is re-enabled. Process 300 is recursive, and returns from block 312 to decision block 302.

I claim:

1. A computer-implemented method, comprising:
detecting whether an input device session has started; and
modifying the display characteristics of a software input panel if the input device session has started.

2. The method as in claim 1, wherein modifying the display characteristics comprises hiding the software input panel if the software input panel is currently displayed on the screen of the mobile device.

3. The method as in claim 1, wherein modifying the display characteristics comprises disabling a software input panel auto-deploy mechanism.

4. The method as in claim 1, wherein modifying the display characteristics comprises:
hiding the software input panel if the software input panel is currently displayed on the screen of the mobile device; and
disabling a software input panel auto-deploy mechanism.

5. The method as in claim 1, wherein detecting whether the input device session has started comprises determining whether a physical keyboard has been attached to the mobile device.

6. The method as in claim 1, wherein detecting whether the input device session has started comprises determining whether a voice dictation device has been attached to the mobile device.

7. The method as in claim 1, wherein detecting whether the input device session has started comprises determining whether one of a set of pre-determined keys has been pressed on a physical keyboard.

8. The method as in claim 7, wherein the set of pre-determined keys comprises the alphanumeric keys on the physical keyboard.

9. The method as in claim 6, wherein the set of pre-determined keys consists of all keys on the physical keyboard except for application keys, direction pads, and rockers.

10. The method as in claim 1, further comprising:
detecting whether the input device session has ended; and
re-enabling the software input panel auto-deploy if the input device session has ended.

11. The method as in claim 10, wherein detecting whether the input device session has ended comprises detecting whether the user has manually launched the software input panel.

12. The method as in claim 10, wherein detecting whether the input device session has ended comprises detecting whether the stylus has been tapped on the screen of the mobile device.

13. The method as in claim 10, wherein detecting whether the input device session has ended comprises detecting whether the stylus has been removed from a holder of the stylus.

14. The method as in claim 10, wherein detecting whether the input device session has ended comprises detecting whether a pre-determined period of time has expired since the user last pressed a key on the input device.

15. A computer-readable medium with computer executable instructions, comprising:
detecting whether an input device session has started; and
modifying the display characteristics of a software input panel if the input device session has started.

16. The computer-readable medium as in claim 15, wherein modifying the display characteristics comprises disabling a software input panel auto-deploy mechanism.

17. A computer-readable medium encoded with computer-executable components, comprising:
a component that is operable to detect whether an input device session has started; and
a component that is operable to modify the display characteristics of a software input panel.

18. The computer-readable medium as in claim 17, wherein the component that is operable to modify the display characteristics comprises a component that is operable to disable a software input panel auto-deploy mechanism.

19. The computer-readable medium as in claim 17, further comprising:
a component that is operable to detect whether a software input panel is currently displayed on a screen of the mobile device; and
a component that is operable to hide the software input panel if the input device session has started and the software input panel is currently displayed on the screen of the mobile device.

20. The computer-readable medium as in claim 19, wherein the component that is operable to detect whether the input device session has started comprises a component that is operable to detect whether one of a set of pre-determined keys has been pressed on an physical keyboard.
